(19) United States
(12) Patent Application Publication
(10) Pub. No.: US 2019/0079299 A1
(43) Pub. Date: Mar. 14, 2019

(54) VIRTUAL IMAGE DISPLAY DEVICE

(71) Applicant: SEIKO EPSON CORPORATION, Tokyo (JP)

(72) Inventors: Toshiaki MIYAO, Matsumoto-shi (JP); Masayuki TAKAGI, Azumino-shi (JP); Takashi TAKEDA, Suwa-shi (JP); Akira KOMATSU, Kamiina-gun (JP); Tokito YAMAGUCHI, Azumino-shi (JP)

(73) Assignee: SEIKO EPSON CORPORATION, Tokyo (JP)

(21) Appl. No.: 16/130,521

(22) Filed: Sep. 13, 2018

(30) Foreign Application Priority Data
Sep. 14, 2017 (JP) 2017-176454

(51) Int. Cl. G02B 27/01; G02B 27/09; G02B 5/30

(52) U.S. Cl. CPC G02B 27/0172; G02B 5/3083; G02B 27/0955; G02B 27/0977

(57) ABSTRACT

By removing part of a lens effective diameter range in a cut lens, a lens is reduced in size and weight in an HMD that trends toward a larger device size. At this time, by making an area to be removed within the lens effective diameter range to be an area on a nose side, reductions in size and weight can be achieved while considering influence on image quality or fitting to a human face.

The present application is based on and claims priority from JP Application Serial Number 2017-176454, filed Sep. 14, 2017, the disclosure of which is hereby incorporated by reference herein in its entirety.

### BACKGROUND

### 1. Technical Field

The disclosure relates to a virtual image display device that is mounted on the head and provides an image formed by an image element or the like to an observer.

### 2. Related Art

In recent years, a virtual image display device (or a head mounted-type display device) such as a head mount display (hereinafter, also referred to as “HMD”) to be mounted on the head of an observer has come to support a wide angle of view. In order to support a wide angle of view, lenses are, in general, likely to become large in diameter, thickness, and the like. However, in the case of the HMD, the lenses are also requested to be small in size and light in weight. In addition, with an increase in lens size or the like, such issues may arise that the disposition of a lens that fits a human face becomes difficult, image quality is affected, and the like.

For example, optical design of the HMD in which a display element and an optical axis of a lens are taken into consideration to improve display quality is known (JP-A-2004-29188). However, whether design further takes into consideration the shape, disposition, or the like of the lens is not clarified.

### SUMMARY

The disclosure provides a virtual image display device that makes it possible to achieve a reduction in size or a reduction in weight of the device which has a trend to become large, while considering influence on the image quality or fitting of the device to a human face.

A virtual image display device according to the disclosure includes an image element configured to display an image, and an asymmetric lens that is disposed in front of an eye of an observer when the virtual image display device is mounted, the asymmetric lens being configured to cause image light from the image element to be emitted toward an observer side, wherein, in an area within a lens effective diameter range, the asymmetric lens includes a lens end face formed in a region on a nose side of the observer when the virtual image display device is mounted.

In the above-described virtual image display device, in the area within the lens effective diameter range, the asymmetric lens includes the lens end face formed in a region on the nose side of the observer when the virtual image display device is mounted, the lens is reduced in size and weight in an HMD that trends toward a larger size. In this case, making a position where the lens end face is disposed to be on the nose side within the lens effective diameter range, the reductions in size and weight of the lens and consequently the reductions in size and weight of the device can be achieved, while considering the influence on the image quality or the fitting of the device to the human face.

In a specific aspect of the disclosure, the lens end face may include a contact portion processed to be flat. In this case, it is possible to determine the position of the asymmetric lens, with high precision and high efficiency, by making use of a flat contact portion. Further, by disposing a flat portion (linear portion) on the nose side, in a case of a configuration including a pair of lenses, the distance between the positions of the right and left lenses can be further shortened.

In another aspect of the disclosure, the asymmetric lenses may be configured to be paired right and left, and the lens end faces may be disposed to be symmetrically slanted with respect to a center axis between the right and left lenses. In this case, a space for the nose of the observer can be secured with good symmetry.

In still another aspect of the disclosure, the asymmetric lens may be a cut lens formed by partially cutting an area in a region on the nose side of the observer within a lens effective diameter range of a circular lens when the device is mounted. In this case, partially cutting the area of the lens in a region on the nose side of the observer within the lens effective diameter range makes it possible to achieve the reductions in size and weight of the lens, and consequently achieve the reductions in size and weight of the device.

In still another aspect of the disclosure, the asymmetric lens may be manufactured by injection molding, and the lens end face may be formed by cutting a side of a molded product where residual stress is relatively large. In this case, it is possible to obtain an appropriate state in which the generation of birefringence in the asymmetric lens is reduced.

In still another aspect of the disclosure, the lens end face may be formed by cutting a section including a gate portion at a time of molding. In this case, the generation of the birefringence in the asymmetric lens can be reduced with ease.

In still another aspect of the disclosure, the asymmetric lens may include the lens end faces in a plurality of locations. In this case, the lens can be formed in a shape further fitted in accordance with characteristics of a human face.

In still another aspect of the disclosure, the asymmetric lens may be a resin lens with a property of zero birefringence or low birefringence. As the resin lens with a property of zero birefringence or low birefringence, a resin lens whose orientational birefringence is not greater than 0.01 and not less than −0.01, or whose photoelastic constant is not greater than 10 [10⁻¹²/Pa] can be considered. In this case, suppressing the generation of birefringence makes it possible to suppress aberration derived from a material and the like, and reduce the weight of the lenses leading to the reduction in weight of the whole device while maintaining optical performance to enhance image quality.

In still another aspect of the disclosure, an attachment section for attaching constituent elements may be further included, and the attachment section may include a position determining portion, the position determining portion being configured to make contact with the lens end face and position the lens end face when the asymmetric lens is to be attached. In this case, by the lens end face making contact with the position determining portion of the attachment section, the attachment of the asymmetric lens can be carried out with high precision and high efficiency.

In still another aspect of the disclosure, a distance from a position at which the eye of an observer is assumed to be present to a position of the asymmetric lens may be within a range from 10 to 30 mm. In this case, the observer can wear the above-described device as an eyeglass-type device without an uncomfortable feeling.

In still another aspect of the disclosure, an optical component disposed before the asymmetric lens may be further included, and the optical component may include an end face formed in a shape corresponding to the lens end face of the asymmetric lens. In this case, along with the asymmetric lens, the optical component disposed on the asymmetric lens can be reduced in size and weight, for example, or the position of the optical component can be precisely and efficiently determined.

In still another aspect of the disclosure, as optical components, there may be provided a display-side lens which is disposed before the asymmetric lens, the display-side lens being configured to allow the image light from the image element to be incident on, a half mirror disposed before the display-side lens, and a semi-transmissive polarization plate disposed between the asymmetric lens and the display-side lens, the semi-transmissive polarization plate being configured to transmit a component in a polarization transmission axis direction. In this case, disposing the half mirror in a light path makes it possible to bend the light path to achieve a wide angle of view and a reduction in size.

In still another aspect of the disclosure, the image element may include an end face formed in a shape corresponding to the lens end face of the asymmetric lens. In this case, it is possible to achieve reductions in size and weight of the image element and consequently the reductions in size and weight of the device while considering the fitting of the device to the human face.

### BRIEF DESCRIPTION OF THE DRAWINGS

Embodiments of the disclosure will be described with reference to the accompanying drawings, wherein like numbers reference like elements.

FIG. 1 is a diagram conceptually describing an exterior appearance and a configuration of a virtual image display device according to First Exemplary Embodiment.

FIG. 2 is a conceptual diagram for describing a disposition and a shape of an asymmetric lens.

FIG. 3 is a conceptual diagram illustrating a relationship between molding of an asymmetric lens and a disposition of the asymmetric lens in a virtual image display device.

FIG. 4 is a diagram conceptually describing an example of a virtual image display device and a light path of image light of the virtual image display device according to the exemplary embodiment.

FIG. 5 is a diagram for describing a relationship between a lens effective diameter range and a shape of an asymmetric lens.

FIG. 6 is a diagram for describing characteristics of a visual field of a human.

FIG. 7 is a diagram for describing an example of molding of an asymmetric lens and an optical component.

FIG. 8 is a diagram for describing an example of molding of an asymmetric lens and an optical component.

FIG. 9A is a diagram for describing one modified example of an asymmetric lens.

FIG. 9B is a diagram for describing another modified example of an asymmetric lens.

FIG. 10 is a diagram conceptually describing a virtual image display device according to Second Exemplary Embodiment.

FIG. 11 is a diagram conceptually describing a virtual image display device of one modified example.

FIG. 12 is a diagram conceptually describing a virtual image display device of another modified example.

FIG. 13A is a diagram illustrating one modified example of a shape of an end face of an asymmetric lens and an optical component.

FIG. 13B is a diagram illustrating one modified example of a shape of an end face of an asymmetric lens and an optical component.

FIG. 14 is a diagram for describing one modified example of a lens end face.

FIG. 15 is a diagram for describing one modified example of dispositions of a lens, an image element, and the like.

### DESCRIPTION OF EXEMPLARY EMBODIMENTS

### First Exemplary Embodiment

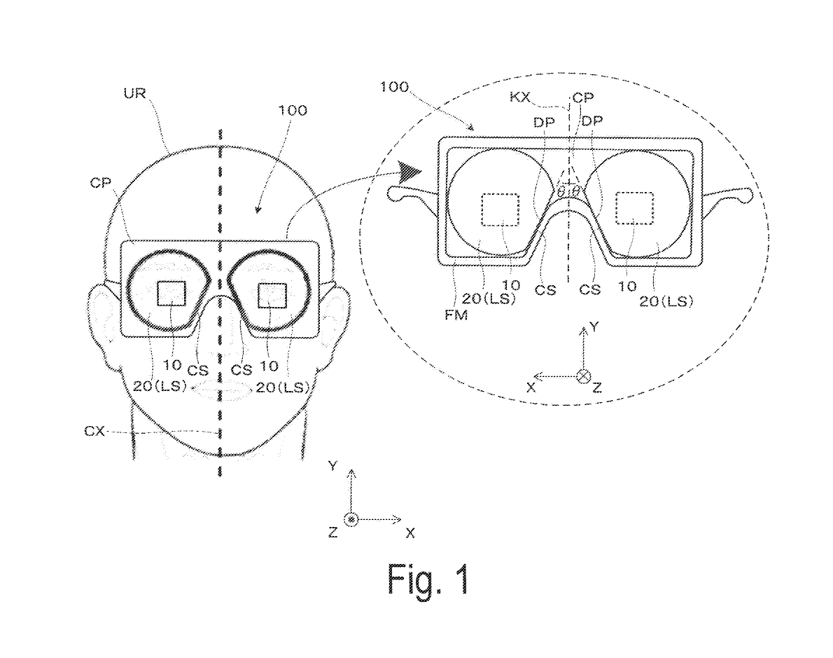

Hereinafter, a virtual image display device according to First Exemplary Embodiment of the disclosure will be described in detail with reference to FIG. 1 and the like.

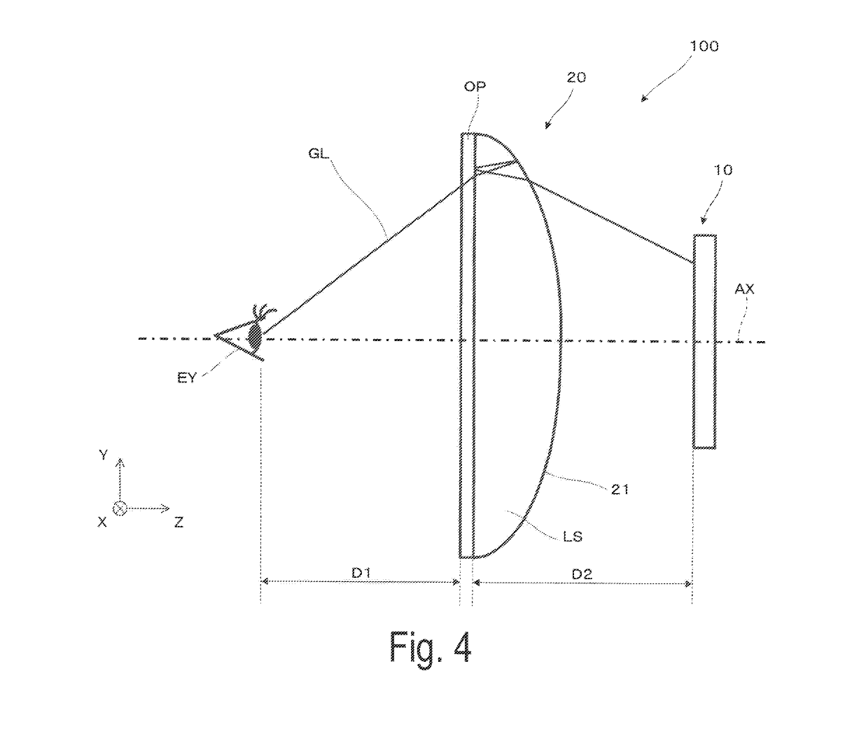

As conceptually illustrated in FIG. 1 and FIG. 4, a virtual image display device 100 of the exemplary embodiment includes an image display unit 10 as an image element (image display section) and an enlargement optical system 20, and serves as a virtual image display device, that is, a head mount display (HMD) capable of causing an observer or a user wearing the virtual image display device 100 to visually recognize picture light (image light) by a virtual image. As illustrated in FIG. 1, the image display unit 10, the enlargement optical system 20, and the like are accommodated and protected in an outer packaging unit CP. Here, as illustrated in FIG. 4 and the like, in the virtual image display device 100 according to the exemplary embodiment, an optical axis AX of the optical system extends in a Z direction. Further, a horizontal direction assumed to be a direction in which the right and left eyes of an observer are aligned is taken as an X direction. An up-down direction for the observer which is a direction orthogonal to the horizontal direction is taken as a vertical direction, and is represented as a Y direction in FIG. 1 and the like.

The image display unit 10 is the image element to display the image. The enlargement optical system 20 is disposed in front of the eye of an observer UR when the device is mounted, and causes the image light from the image display unit 10 to be emitted toward an observer side. The enlargement optical system 20, while taking a lens as a main member, is configured with optical components such as a polarization conversion member and a semi-transmissive polarization plate. A specific example will be described with reference to FIG. 4.

As illustrated in the drawing, the lens as the main member in the enlargement optical system 20 has such a shape (D shape) that is obtained by cutting part of a circular lens shape, which is a regular lens shape, in a front view. In particular, in the exemplary embodiment, part of a portion of the lens corresponding to an area on a nose side of the observer when the device is mounted is removed (cut) slantingly. Here, such a lens that is formed in a shape in which a regular circular lens shape is partially cut, in other words, a lens formed in a shape less symmetric than a circular lens, is referred to as an asymmetric lens or a cut lens. In addition, an end face of the lens formed on a portion cut in a cutout shape is referred to as a lens end face. In other words, referring to FIG. 1 and the like, it can be understood that the main member in the enlargement optical system 20 is a cut lens LS, which is an asymmetric lens, and the cut lens LS includes a lens end face CS that is flat (linear). Further, as partially enlarged and illustrated in FIG. 1, when the virtual image display device 100 is viewed from a reverse side (rear side), in the enlargement optical system 20 or the cut lens LS, the lens end face CS makes contact with a slant and flat (linear) position determining portion DP of a frame FM as an attachment section disposed in the outer packaging unit CP, by making use of the lens end face CS being slanted and flat (linear). Thus, the attachment of the lens can be carried out with high precision and high efficiency in comparison with a case of position determination (position adjustment) of a circular lens in a rotatable state, for example. To rephrase, the cut lens LS uses, when being attached on the position determining portion DP of the frame FM, the lens end face CS as a contact portion processed to be flat.

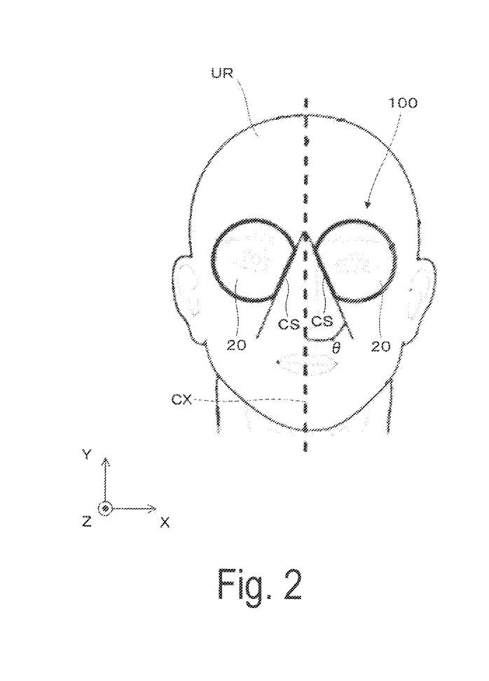

Further, for example, as illustrated in FIG. 2, the virtual image display device 100 is disposed such that the lens end faces CS and CS are slanted in a horizontally symmetric manner with respect to a center axis CX of the face of the observer UR in the enlargement optical systems 20 and 20 that are paired right and left. In the case where the above configuration is explained using only the configuration of the virtual image display device 100 without referring to the observer UR, the virtual image display device 100 has a structure that is horizontally symmetric with respect to a center axis KX between the right and left lenses (see the partially enlarged view in FIG. 1) corresponding to the center axis CX. Accordingly, it can be stated that the pair of lens end faces CS and CS are disposed being slanted in a horizontally symmetric manner with respect to the center axis KX, in other words, the lens end faces have slant angles θ of an identical magnitude. The magnitude of the slant angle θ of each lens end face CS with respect to the center axis KX (center axis CX) can take various values within a range from 0° to 90° by optical design and the like, and is determined to be within an appropriate range while considering influence on the image quality or fitting to a human face and the like, as described later. As a specific numeric value, a case of θ being approximately 30° or being within a range from 20° to 40° can be considered.

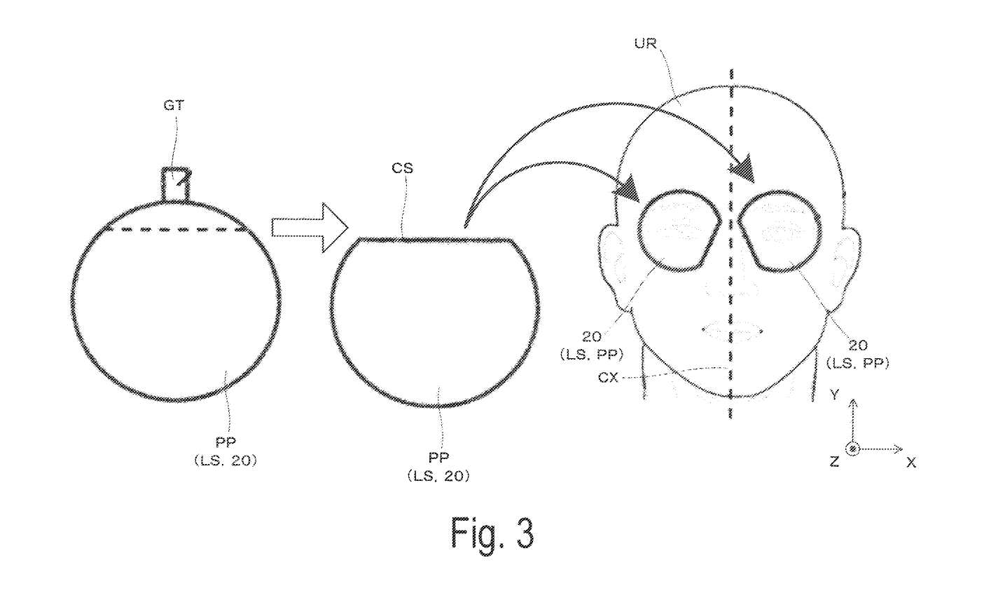

As an example illustrated in FIG. 3, in the exemplary embodiment, the enlargement optical system 20 or the cut lens LS is manufactured by injection molding, and the lens end face CS is formed by cutting a section, of a member PP that is to be the cut lens LS that is a molded product by the injection molding, including a portion of a gate GT at the time of molding. In a gate peripheral section when molding a resin lens, residual stress is likely to be generated being related to fluidity at the molding time. Accordingly, cutting the section including the portion of the gate GT makes it possible to cut a portion on a side where the residual stress is relatively large, and achieve an appropriate state in which the generation of birefringence in the cut lens is reduced.

With reference to FIG. 4, conceptual description of examples regarding the structures and the like of constituent elements to perform light-guiding of image light by the virtual image display device 100 will be given below.

FIG. 4 illustrates a state of a cross section along the optical axis AX when viewed from a side in the case where the observer wears the virtual image display device 100. As illustrated in FIG. 1, the image display units 10 as well as the enlargement optical systems 20 are configured to be paired right and left for use by the right and left eyes, respectively. However, herein, of the paired members for use by the right and left eyes, only the image display unit 10 and the enlargement optical system 20 for use by one of the eyes (left eye) are illustrated while omitting the other members due to their symmetric structure in a right-left direction. That is, in FIG. 4, a positive X (+X) side refers to an outer side (an ear side), and a negative X (−X) side refers to an inner side (a nose side). Note that only one side of the pair of right and left members, that is, even a configuration including a single image display unit 10 and a single enlargement optical system 20, functions by itself as a virtual image display device. Although detailed description is omitted herein, the virtual image display device may not be configured to be paired right and left as exemplified in FIG. 1, and may also be configured in preparation for use by a single eye.

The image display unit 10 is a unit, serving as an image element to display an image, configured to form an image at a panel section as a main body section, and emits image light GL having been formed as image light while converting a polarization state of the image light GL as needed. The image display unit 10 can be configured with an image element (picture display element) configured of a light-emitting type element (OLED) such as an organic EL element, for example. Further, the image display unit 10 may be configured to include, for example, in addition to the picture display element (image element) as a transmissive-type space optical modulator, an illumination unit (not illustrated) as a back light configured to emit illumination light to the image element, a drive control unit (not illustrated) to control the operations, and the like.

The enlargement optical system 20 includes, in addition to the cut lens LS as the main member, a half mirror 21 and an optical element OP. The cut lens LS is made of any one of a resin lens with a property of zero birefringence and a resin lens with a property of low birefringence, so that the birefringence is unlikely to be generated.

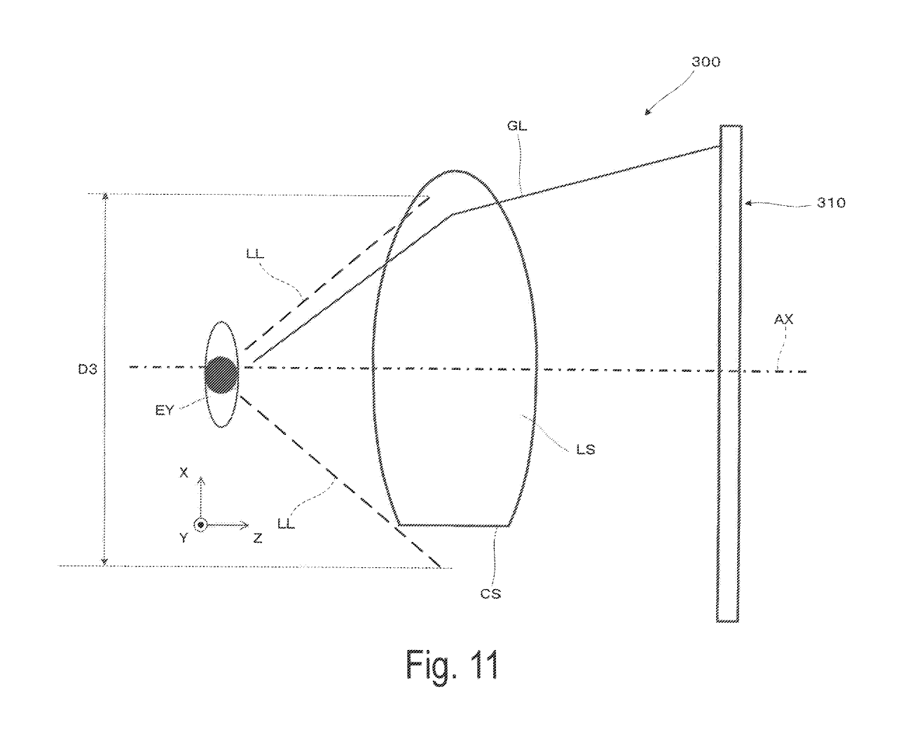

The cut lens LS of the enlargement optical system 20 is an observer-side lens disposed opposing a position that is assumed to be a position of the eye EY of the observer (in this application, this position is also indicated by the eye EY). In other words, the cut lens LS is a convex lens configured to collect the image light GL from the image display unit 10 and make the collected light emit toward a front side of the eye of the observer. The cut lens LS is considered to be the observer-side lens, that is, the lens positioned on the eye EY side of the observer, and its distance, to be specific, a distance D1 from the position at which the eye EY of the observer is assumed to be present to the cut lens LS is considered to be within a range from 10 to 30 mm. In this case, the observer can wear the above-described device as an eyeglass-type device without an uncomfortable feeling. In particular, it is advantageous for the value of the distance D1 to be within a range from 15 to 20 mm. A distance that is within the above range is typically assumed to be a distance from the eye to the lens in the case of regular glasses. Meanwhile, a distance D2 from the cut lens LS to the image display unit 10 is within a range from 20 to 50 mm by optical design. In particular, in the case where a small-sized panel (a panel smaller than the lenses) is employed in the image display unit 10 as in the exemplary embodiment, the distance D2 can be considered to be further shortened compared to a case of employing a large-sized panel (see FIG. 11 and the like). Note that, however, the distance D1 is within a set range regardless of the size of the image display unit 10 because of a request to serve as the above-mentioned eyeglass-type device. Accordingly, the cut lens LS comes relatively close to the position of the observer. Furthermore, from the standpoint of achieving a wide angle of view and the like, it cannot be avoided to cut part of the lens with an increase in size of the lens in order to maintain an angle of view to some extent.

The half mirror 21 is a semi-reflective and semi-transmissive film for transmitting part of the image light GL and reflecting another part of the image light GL, and is formed with a dielectric multilayer film and the like, for example. The half mirror 21 is disposed before the cut lens LS, that is, on an upstream side of a light path of the image light GL, and is formed in a concavely curved shape when viewed from the observer side. In the example illustrated in the drawing, among lens surfaces of the cut lens LS, the half mirror 21 is attached to a surface of the cut lens LS on the upstream side of the light path.

The optical element OP is a member that is configured, for example, with a semi-reflective and semi-transmissive film, or configured by combining semi-transmissive polarization plates formed of a quarter wavelength plate (¼ λ plate) or a wire grid polarization plate, and the like, and selectively transmits and reflects the image light GL or transmits and reflects part of the image light GL. The optical element OP is disposed after the cut lens LS, that is, on a downstream side of the light path of the image light GL. In the example illustrated in the drawing, among the lens surfaces of the cut lens LS, the optical element OP is attached to a surface of the cut lens LS on the downstream side of the light path.

Hereinafter, the light path of the image light GL will be generally described. First, the image light GL emitted from the image display unit 10 passes through the half mirror 21 of the enlargement optical system 20, and reaches the optical element OP through the cut lens LS. Here, part of the image light GL is reflected and reaches the half mirror 21 again. In the half mirror 21, part of components of the image light GL pass through as they are, and remaining components are reflected. The reflected components of the image light GL reach the optical element OP through the cut lens LS, and part of those components pass through the optical element OP to reach a position assumed to be a position where the eye EY of the observer is present.

In the exemplary embodiment, disposing the half mirror 21 in the light path of the virtual image display device 100 makes it possible to bend the light path and cause the light to travel back and forth between the half mirror 21 and the optical element OP, and thus a wide angle of view and a reduction in size can be achieved. In addition, by adequately managing states of the image light GL components to be reflected and transmitted, it is possible to suppress the generation of ghost light and cause an image with high quality to be visually recognized by the observer, for example.

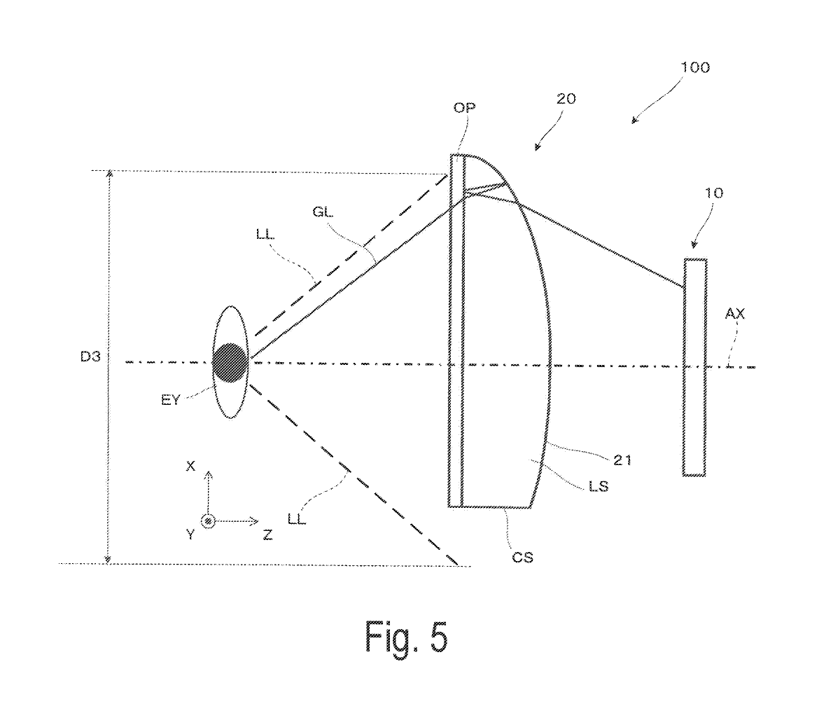

With reference to FIG. 5 and the like, a relationship between a lens effective diameter range of the cut lens LS and a shape of the cut lens LS will be described. FIG. 5 illustrates a state of a cross section along the optical axis AX when viewed from above in the case where the observer wears the virtual image display device 100. As described above, the cut lens LS includes the lens end face CS formed by the lens being cut in a slanting direction relative to the center axis direction, that is, the up-down direction (Y direction). The cut lens LS is in a state in which part of the range of an original effective diameter D3 (in other words, an effective diameter that would be obtained when the cutting were not carried out) of the cut lens LS illustrated in FIG. 5 is cut. That is, although the range of an angle of view indicated by broken lines LL in the drawing is originally a visually recognizable range, the image light GL does not come from the part of that range. In this case, part of the image may be dark or lacking. However, in the exemplary embodiment, by determining a range to be cut in accordance with characteristics of a visual field of a human, a situation in which the visibility is degraded is prevented.

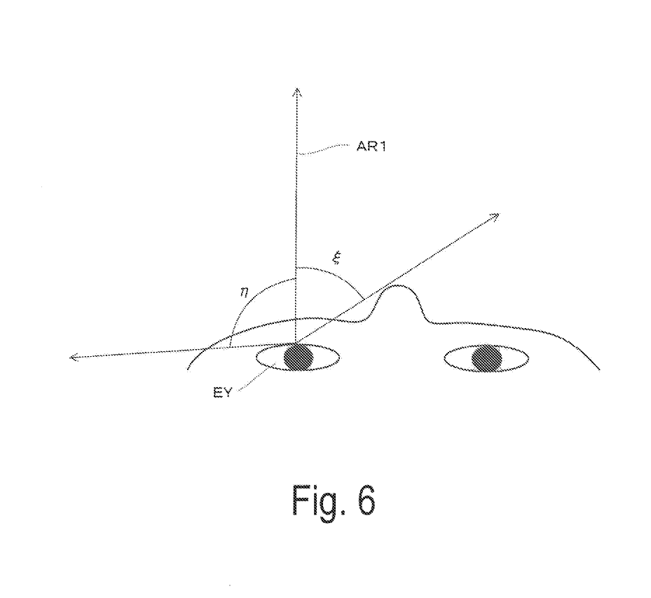

FIG. 6 is a diagram for describing an example of characteristics of a visual field of the human. In general, a human visual field in a nose-side direction (inner side direction) is smaller than a visual field in an ear-side direction (outer side direction). Due to this, it is well-known that, when only the angle of view on the nose side for the image light is made small, the overall visual field is not largely affected. Specifically, in FIG. 6, when a front direction of a visual field indicated by an arrow mark AR1 is taken as a reference direction, a visual field angle ξ in the nose-side direction (inner side direction) relative to the reference direction is smaller than a visual field angle η in the ear-side direction (outer side direction). For example, the visual field angle η is not less than 90°, while the visual field angle ξ is approximately 600. In addition, the range of a visual field in which the image can be viewed with a high level of resolution ability is further limited. Because of this, when an object (image portion) which an observer wants to view is present at a larger angle to some extent away from the front of the observer, the observer attempts to place the object in front of the observer by moving not only the eyes but also the head. Meanwhile, a recent device for image formation of so-called virtual reality (VR) is provided with a head tracking function, which follows movement of the head of the observer of the HMD, and provides an image in accordance with the movement of the head. In consideration of the above, the lens end face CS is formed in the cut lens LS by cutting part of the area of the lens on the nose side of the observer when the device is mounted within the lens effective diameter range while preventing a situation in which visibility in terms of appearance is degraded.

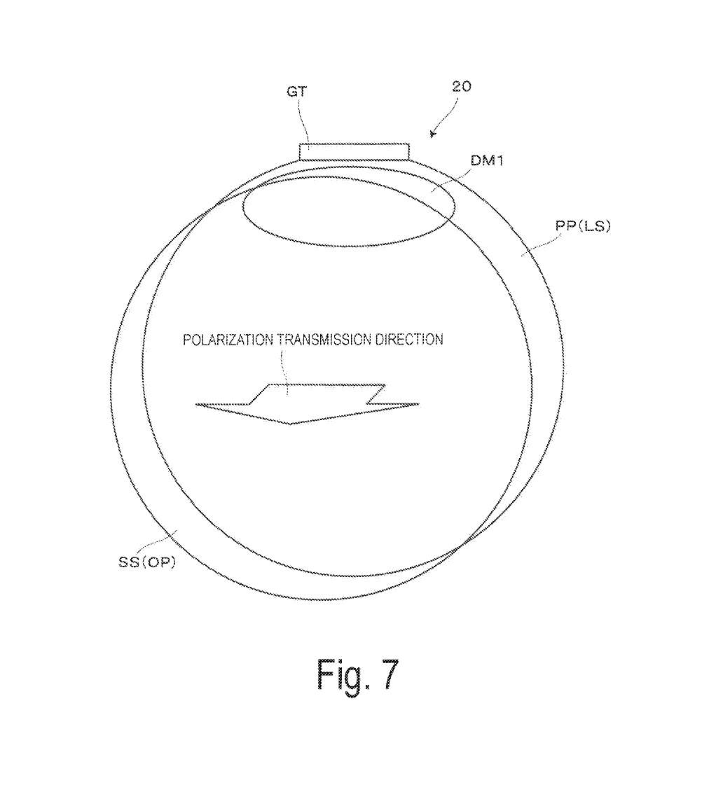

An example of manufacturing of the enlargement optical system 20 including molding of lenses such as the cut lens LS will be described below with reference to FIG. 7 and the like.

As described above with reference to FIG. 1 and the like, it is advantageous for the cut lens LS to be configured of a resin lens with a property of zero birefringence or a resin lens with a property of low birefringence. This is because birefringence significantly affects transmittance of the polarization plate and the like when the light passes through, and causes large luminance unevenness, color unevenness (color aberration), and the like to be generated. In particular, since the image light GL passes in the cut lens LS a total of three times by traveling back and forth, it is necessary to apply a material with smaller birefringence to the cut lens LS. From the viewpoint of suppressing birefringence, using glass can suppress the influence of birefringence with respect to the above-described portion. However, since there is also a need for the HMD to be light in weight, it is preferable to use a resin lens from the viewpoint of reducing weight. Then, a case in which the cut lens LS and the like is configured with a resin lens will be described here. As a resin with a relatively low birefringence, PMMA, ZEONEX, and the like can be cited. Note that, for example, Iupizeta EP-4000 to 6000 are developed by Mitsubishi Gas Chemical Company, Inc. as resins with lower birefringence. Herein, a lens configured with these materials is referred to as a resin lens with a property of low birefringence or a resin lens with a property of zero birefringence.

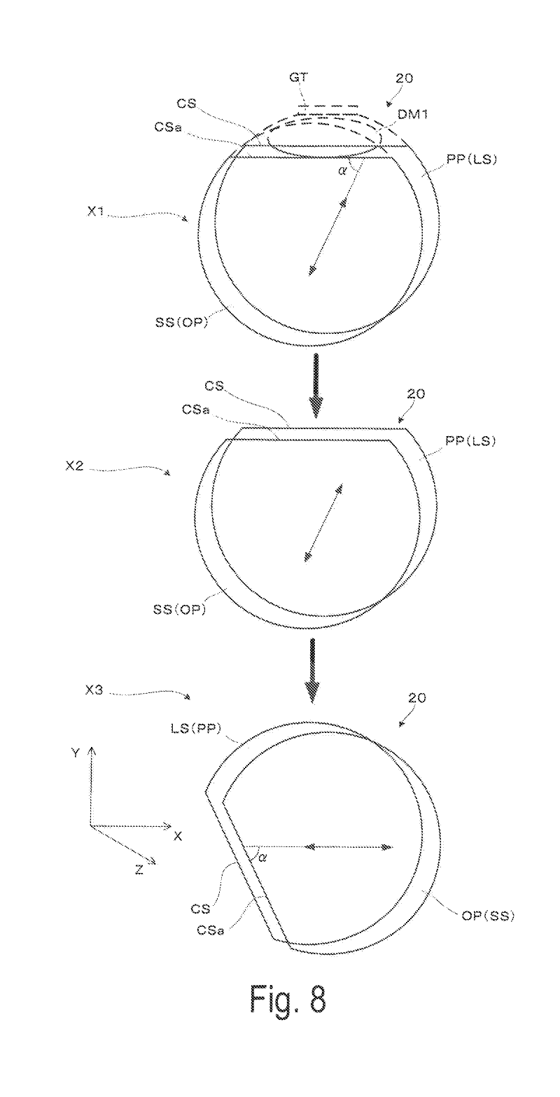

Each of FIGS. 7 and 8 is a diagram for describing an example of a processing step of a section including the cut lens LS and optical components (for example, the optical element OP) in the manufacturing of the enlargement optical system 20.

In a gate peripheral section at a time of molding a resin lens, as illustrated by an area DM1 in FIG. 7, residual stress is likely to be generated in relation to the fluidity at the molding time. Due to this, light having passed through a section like the area DM1 is likely to be influenced by luminance unevenness, color unevenness (color aberration), and the like, and therefore the above-mentioned gate peripheral section is not suitable for use as the cut lens LS. Then, in FIG. 8, processing of the member PP that is to be the cut lens LS indicated by states X1 to X3 as the respective steps will be described below. First, as illustrated in the state X1 and the state X2, part of the member PP including a portion of the gate GT is removed by cutting, so that the member PP is formed in a D shape (D cut). Thus, the lens end face CS is formed, and the section where the residual stress is likely to be generated, like the area DM1 on the gate GT side including the gate GT, can be removed. In the cut member PP, the lens end face CS is used in positioning the attachment to the position determining portion DP (see FIG. 1) of the frame FM in a slant state at a specific angle, as illustrated in the state X3.

Further, as described above, in accordance with the member PP that is to be the resin lens illustrated in FIGS. 7 and 8, a member SS that is to be the optical element OP may also be bonded with the orientation corresponding to the member PP that is to be the lens. As exemplified in FIG. 4, in the case of the configuration in which the optical element OP is bonded to the cut lens LS, it is advantageous that the optical element OP is also cut in accordance with the lens end face CS of the cut lens LS, that is, the optical element OP includes an end face CSa being cut corresponding to the shape of the lens end face CS. Further, in the case of the configuration in which semi-transmissive polarization plates formed of a quarter wavelength plate or a wire grid polarization plate are combined as the optical element OP, it is advantageous that the direction of a polarization axis P1 (for example, a polarization transmission axis) such as the direction of the polarization transmission axis is adjusted to take a specified direction at the time of attachment. Accordingly, in the example of FIG. 8, as illustrated in the state X3, by causing the polarization axis P1 of the optical element OP to be at a specific angle α with respect to the end face CSa or the lens end face CS, the attachment to the position determining portion DP (see FIG. 1) of the frame FM is carried out and the polarization axis P1 is made to be parallel to the X direction (horizontal direction). That is, as illustrated in the state X1 and the state X2, when part of the member SS that is to be the optical element OP is cut and removed to form the end face CSa, the orientation of the end face CSa and the direction of the polarization axis P1 of the member SS are made to be at the angle α. As a specific numeric value, a case of α being approximately 60° or being within a range from 50° to 70° may be considered.

As discussed thus far, by disposing the gate GT portion at the D-cut target section, a section like the area DM1 can be easily removed, and the gate GT with a larger cross-sectional area can be disposed. This makes it possible to improve formability and more precisely, in addition suppress the generation of flow marks. The cut lens LS may be mechanically cut after having been formed in a circular shape. Moreover, various kinds of aspects for the optical element OP can be conceived such that the optical element OP is individually cut and then is bonded to the cut lens LS, the member SS that is to be the optical element OP is bonded to the member PP that is to be the cut lens LS and then is collectively cut, and the like. According to the above methods, by cutting part of the portion including the gate GT, a configuration in which the area DM1 where the residual stress is large is used as little as possible in the cut lens LS can be employed, or the positioning of the optical element OP can be carried out in accordance with characteristics of the optical element OP, and the like.

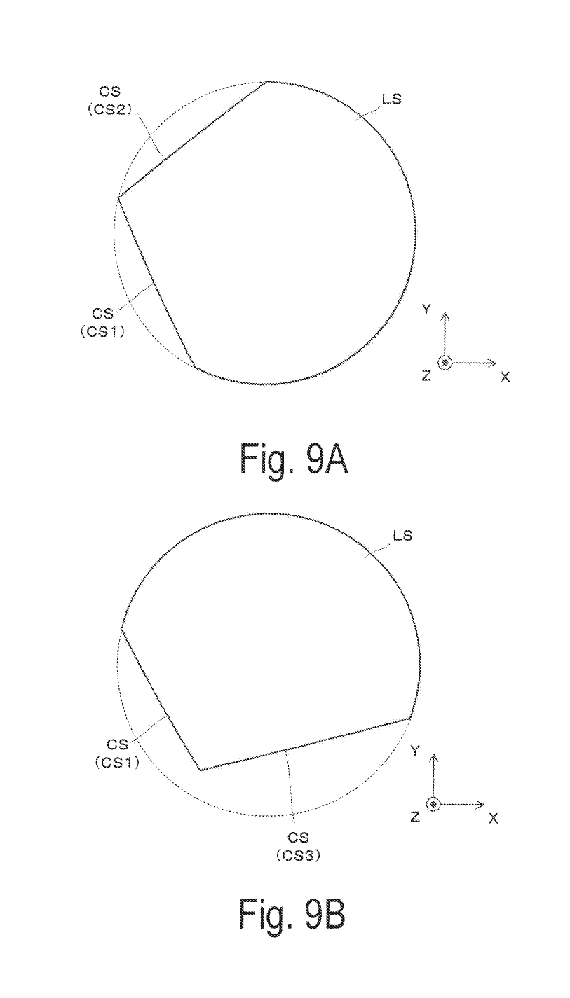

Hereinafter, with reference to FIG. 9A and FIG. 9B, a modified example of the optical components such as the cut lens LS, the optical element OP and the like, or of the enlargement optical system 20 configured by these optical components will be described. Here, a modified example of the cut lens LS will be described as representative. As illustrated in the drawings, a case in which the cut lens LS includes the lens end faces CS at a plurality of locations will be described. In an example of the modification, the cut lens LS includes lens end faces CS at two sections, which form a V cut shape.

First, in a case of one modified example illustrated in FIG. 9A, in addition to a lens end face CS1, as a lens end face CS, formed by partially removing an area on the nose side of an observer when the device is mounted within a lens effective diameter range, a lens end face CS2, as another lens end face CS, is disposed on an upper side (+Y side) relative to the lens end face CS1. For example, for an observer with a face in which there is a large projection near the forehead or the eye, disposing the lens end face CS2 makes it easy to fit the device to the face. The visual field angle of the human is approximately 75° in a downward direction and is approximately 50° in an upward direction. That is, the visual field in the upward direction is narrower than that in the downward direction. Accordingly, cutting on the upper side of the lens is considered to be easy.

In a case of another modified example illustrated in FIG. 9B, in addition to a lens end face CS1 as a lens end face CS, a lens end face CS3, as another lens end face CS, is disposed on an outer side (+X side) relative to the lens end face CS1. For example, for an observer with a face in which there is a large projection near the cheek, disposing the lens end face CS3 makes it easy to fit the device to the face. Note that the above section is positioned on the outer side and a lower side. Therefore, the cutting of the section is considered to be easy from the viewpoint of the visual field angle of the human.

Although, in the above example, the V cut shape is formed by cutting two sections, the example is not limited to the above shape. For example, a configuration in which end surfaces made by cutting two sections distanced from each other are disposed, or in which end faces are disposed at three or more sections may be employed.

As discussed thus far, in the virtual image display device 100 of the exemplary embodiment, by cutting part of the cut lens LS within the lens effective diameter range, the lens is reduced in size and weight in the HMD that trends toward a larger device size. At this time, by making an area to be removed within the lens effective diameter range to be an area on the nose side, the reductions in size and weight of the lens and consequently the reductions in size and weight of the device can be achieved, while considering the influence on the image quality or the fitting to a human face.

### Second Exemplary Embodiment

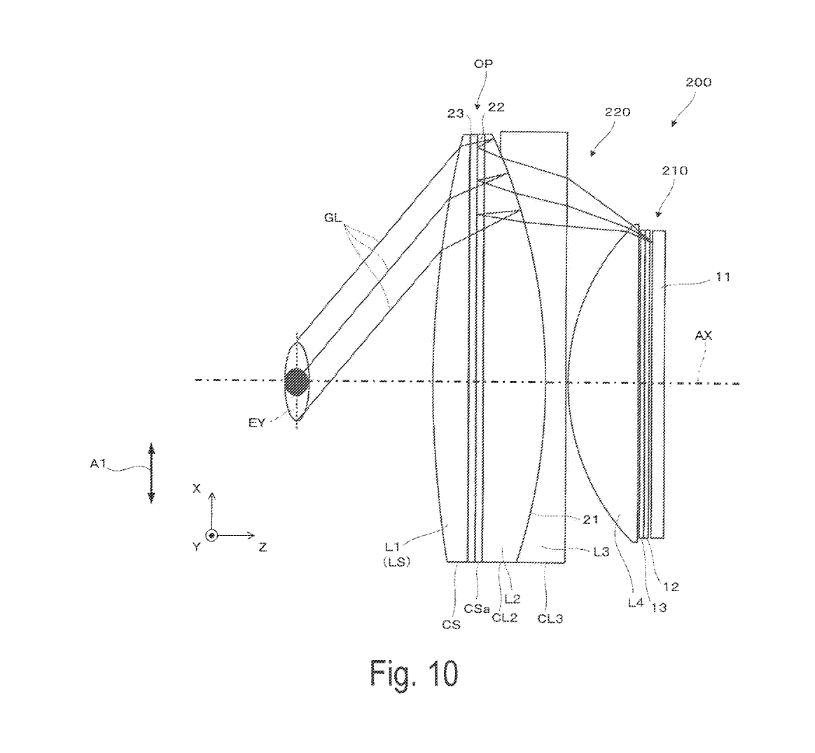

Hereinafter, a virtual image display device according to Second Exemplary Embodiment will be described with reference to FIG. 10. In a virtual image display device according to the exemplary embodiment, lenses serving as the main member in an enlargement optical system is configured of a plurality of lenses, while in the virtual image display device of First Exemplary Embodiment, the lens serving as the main member in the enlargement optical system is configured of a single cut lens. As such, the virtual image display device of the exemplary embodiment differs from First Exemplary Embodiment in that point. An exterior appearance configuration and the attachment of the enlargement optical system are similar to those of First Exemplary Embodiment (see FIG. 1), and thus illustrations and descriptions of the exterior appearance configuration and of the attachment of the enlargement optical system are omitted.

A virtual image display device 200 according to the exemplary embodiment includes an image display unit 210 as an image element and an enlargement optical system 220.

The image display unit 210 includes a panel section 11 as a principal main body section configured to perform image formation, a polarization plate 12 configured to extract a component of linearly polarized light, and a first quarter wavelength plate (λ/4 plate) 13 configured to circularly polarize the component having passed through the polarization plate 12 and emit the component.

The panel section 11 can be an image element (picture display element) configured of a light-emitting type element (OLED) such as an organic EL element, for example. Further, the image display unit 210 may be configured to include, for example, in addition to the picture display element (image element) as a transmissive-type space optical modulator, an illumination unit (not illustrated) as a back light configured to emit illumination light to the picture display element, a drive control unit (not illustrated) to control the operations, and the like.

The polarization plate 12 linearly polarizes image light that is to be emitted of the light from the panel section 11. Further, the first quarter wavelength plate 13 circularly polarizes the component having passed through the polarization plate 12.

With the above-described configuration, the image display unit 210 emits circularly polarized image light GL.

The enlargement optical system 220 includes a half mirror 21 and an optical element OP in addition to four lenses, that is, first to fourth lenses L1 to L4 aligned in that order from the observer side. The optical element OP is configured with a polarization conversion member 22 and a semi-transmissive polarization plate 23. Among these, while excluding the fourth lens L4, the first to third lenses L1 to L3, the half mirror 21, and the optical element OP are bonded with each other to be unitized as illustrated in the drawing. Here, the above unitized members are formed in a shape, part of which is cut. Of the first to fourth lenses L1 to L4, it is advantageous that at least the second lens L2 is configured with any one of a resin lens with a property of zero birefringence and a resin lens with a property of low birefringence so that the birefringence is unlikely to be generated.

In the enlargement optical system 220, the first lens L1 is an observer-side lens which is disposed at a position closest to a position of the eye EY of the observer, and corresponds to the cut lens LS in First Exemplary Embodiment. The first lens L1 as the observer-side lens is a convex lens configured to collect the image light GL and make the collected light emit toward a front side of the eye of the observer.

The second lens L2 is a lens that is disposed upstream, in terms of a relative relationship with the first lens L1, and makes the image light GL from the image display unit 210 enter into the optical members disposed after the first lens L1. Here, the second lens L2 is also referred to as a display-side lens with respect to the first lens L1 (observer-side lens). The second lens L2 is a convex lens serving as a refractive lens whose refractive index is, for example, no less than 1.55 to allow the image to have a sufficiently wide angle of view. In this example, the second lens L2 also includes an end face CL2 prepared by cutting corresponding to the first lens L1 that is a cut lens.

The third lens L3 is an achromatic lens which is disposed before the second lens L2 that is the display-side lens, and in which the Abbe number is appropriately adjusted. The third lens L3 is a concave lens disposed being bonded to the second lens L2 to function as a lens aiming for achromatism. Here, specifically, the third lens L3 is bonded with the second lens L2 in such a manner as to sandwich the half mirror 21 between the second and third lenses L2 and L3. In this example, the third lens L3 also includes an end face CL3 prepared by cutting corresponding to the first lens L1 that is a cut lens.

The fourth lens L4 is a convex lens that is disposed immediately after the image display unit 210, and emits the image light GL from the image display unit 210 toward the optical members that are disposed after third lens L3, including the third lens L3. To rephrase, in the enlargement optical system 220, the fourth lens L4 is an upstream-side lens that is disposed at a position closest to the image display unit 210 and adjusts a light path of the image light GL. Disposing the fourth lens L4 makes it possible to further improve resolution performance and reduce the panel size in the image display unit 210. Accordingly, it is also possible to reduce the manufacturing cost of the image display unit 210. In addition, since a telecentric angle of a light beam emitted from the image display unit 210 can also be reduced, the generation of variations in luminance and chromaticity due to panel visual field angle characteristics can be suppressed. In this example, the fourth lens L4 is a circle-shaped lens that is uncut.

The half mirror 21 is, as discussed above, a semi-reflective and semi-transmissive film for transmitting part of the image light and reflecting another part of the image light, and is formed with a dielectric multilayer film and the like, for example. The half mirror 21 is formed between the second lens L2 and the third lens L3, and has a shape of a curved surface in a concave form when viewed from the observer side.

In the optical element OP, the polarization conversion member 22 is a member for converting a polarization state of the light passing through, and is configured with a quarter wavelength plate (a second ¼ wavelength plate or a second λ/4 plate) here. The polarization conversion member 22 is disposed between the second lens L2, that is the display-side lens, and the semi-transmissive polarization plate 23, and converts a polarization state of the component traveling back and forth between the polarization conversion member 22 and the half mirror 21, such as a component traveling toward the semi-transmissive polarization plate 23 and the like. Here, the image light GL in a circularly-polarized state is converted into a linearly-polarized state, or conversely, the image light GL in the linearly-polarized state is converted into the circularly-polarized state.

In the optical element OP, the semi-transmissive polarization plate 23 is a member disposed between the second lens L2 that is the display-side lens and the first lens L1 that is the observer-side lens, and is configured with a reflective wire grid polarization plate here. Particularly, in the exemplary embodiment, a polarization transmission axis direction A1 of the semi-transmissive polarization plate 23 that is a wire grid polarization plate is taken as a horizontal direction (X direction) assumed to be a direction in which the eyes are aligned. The semi-transmissive polarization plate 23 configured with the reflective wire grid polarization plate is also referred to as a reflective polarization plate in some cases because its transmission and reflection characteristics are changed in accordance with a polarization state of the entering component.

In the optical element OP, in a similar manner to that described in First Exemplary Embodiment, angle adjustment for a side surface CSa has been performed with respect to the respective polarization axis directions to satisfy the transmission and reflection characteristics in accordance with the above-described polarization state (see FIG. 8).

Hereinafter, the light path of the image light GL will be generally described. Here, as described before, the semi-transmissive polarization plate (or the reflective polarization plate) 23 configured with the wire grid polarization plate takes the horizontal direction (X direction) as a direction of the polarization transmission axis. That is, the semi-transmissive polarization plate 23 has characteristics configured to transmit the polarization component in the X direction and reflect the component perpendicular to the X direction. The light path of the image light GL indicated in the drawing extends passing through an in-plane parallel to an X-Z plane. Accordingly, in the drawing, when P-polarized light and S-polarized light are defined, an incident surface is taken as a surface parallel to the X-Z plane, and a boundary surface is taken as a surface perpendicular to the X-Z plane (a surface parallel to the Y direction). The semi-transmissive polarization plate 23 transmits P-polarized light and reflects S-polarized light.

With the configuration discussed above, first, the image light GL having been modulated in and emitted from the panel section 11 of the image display unit 210 is converted to P-polarized light in the polarization plate 12 that is a transmissive wavelength plate, and thereafter is converted to circularly-polarized light by the first quarter wavelength plate 13 and then emitted toward the enlargement optical system 220. Thereafter, the image light GL enters the third lens L3 in the enlargement optical system 220 through the fourth lens L4, and reaches the half mirror 21 film-formed on an interface with the second lens L2. Part of the components of the image light GL pass through the half mirror 21 and are converted to S-polarized light in the polarization conversion member 22 that is the second quarter wavelength plate, and the S-polarized light reaches the semi-transmissive polarization plate (or the reflective polarization plate) 23. Here, the image light GL as S-polarized light is reflected by the semi-transmissive polarization plate 23, becomes circularly-polarized light again in the polarization conversion member 22, and then reaches the half mirror 21. In the half mirror 21, part of the components of the image light GL pass through as they are, and the remaining components are reflected. The reflected components of the image light GL are converted to P-polarized light this time in the polarization conversion member 22. The components of the image light GL being P-polarized light pass through the semi-transmissive polarization plate 23 to reach the first lens L1 (the observer-side lens). The image light GL, after passing through the first lens L1, reaches a position assumed to be a position where the eye EY of the observer is present.

As discussed thus far, also in this exemplary embodiment, by cutting part of the first lens L1 corresponding to the cut lens LS within the lens effective diameter range, and further cutting part of the various types of optical components associated with the first lens L1, the lens is reduced in size and weight in the HMD that trends toward a larger device size. At this time, by making an area to be removed within the lens effective diameter range to be an area on the nose side, the reductions in size and weight of the lens and consequently the reductions in size and weight of the device can be achieved, while considering the influence on the image quality or the fitting to a human face. In particular, as for the polarization conversion member 22 and the semi-transmissive polarization plate 23 configuring the optical element OP, since the polarization axis (polarization transmission axis) A1 is in accordance with the side surface CSa in advance to achieve the above-mentioned functions, it is possible to perform highly precise and efficient positioning. In addition, in the exemplary embodiment, by disposing the half mirror 21 in the light path of the virtual image display device 200 to bend the light path, a wide angle of view and miniaturization of the device are achieved. Along with this, by disposing the polarization conversion member 22 between the half mirror 21 and the semi-transmissive polarization plate 23, the polarization state of the component traveling back and forth between the half mirror 21 and the semi-transmissive polarization plate 23 can be appropriately converted, the generation of ghost light is suppressed, and a high quality image can be visually recognized by the observer.

### Other Exemplary Embodiments

Thus far, the disclosure has been described based on some exemplary embodiments. Note that, however, the disclosure is not limited to the above-described exemplary embodiments, and can be embodied in various aspects without departing from the spirit and scope of the disclosure.

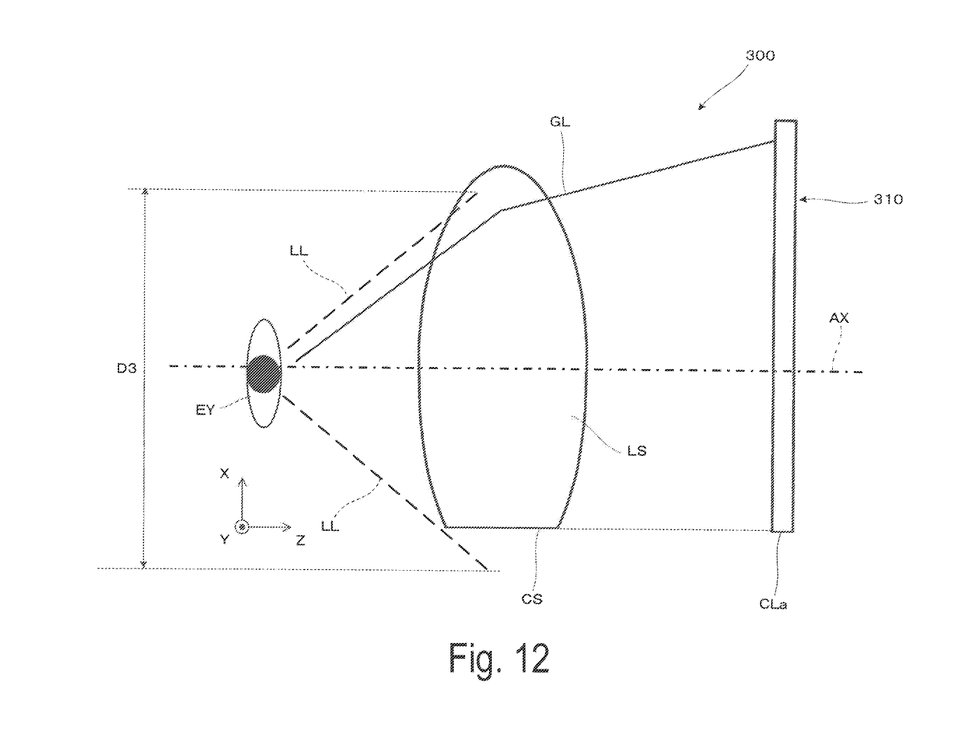

In the above-described examples, small-sized panels are employed, and particularly the image display units 10 and 210 are small in size compared to the lenses. However, for example, as illustrated in FIGS. 11 and 12, in a virtual image display device 300 using an image display unit 310 configured with a large-sized panel, a cut lens LS including a lens end face CS may be employed.

In each of the above-described embodiments, in the enlargement optical systems 20 and 220, a structure partially including a bending of the light path is employed. However, the above-described cut lens can also be employed in a structure not including the bending of the light path (see FIGS. 11 and 12). In this case, there are a plurality of lenses configuring the enlargement optical system, and as in Second Exemplary Embodiment, only part of the plurality of lenses may be cut, or all the lenses may be cut. For example, from the viewpoint of the above-described distance D1, although cutting needs to be carried out on at least an optical system at a position closest to the observer, cutting is not particularly necessary to be carried out on a lens at a position relatively separate from the observer, a lens small in size, and the like. Further, in a case of a structure not including a bending of the light path, a case of a lens not including a bending of the light path despite the structure partially including a bending of the light path, and the like, use of a resin lens with a property of zero birefringence or a resin lens with a property of low birefringence unlikely to generate birefringence is not absolutely necessary, so manufacturing the lens using a low-cost material can also be considered. In this case, although such a possibility that there exists a section where residual stress is large is further raised, particularly in the vicinity of the gate, cutting the section makes it possible to obtain appropriate optical performance even when a low-cost material is used. In addition, employing a glass lens for part of or all of the lenses can also be considered.

In addition to the cutting on the optical system such as the lens, cutting may also be carried out on the image display unit 310, that is, on part of the panel, as illustrated in FIG. 12. In other words, the image display unit 310 as an image element may include an end face CLa formed in a shape corresponding to the lens end face CS of the cut lens LS.

In the above description, the lens end face CS, each of the end faces CSa, and the like are considered to be flat (linear). However, for example, not the entirety of, that is, only part of the lens end face CS may be processed to be flat, and another part of the lens end face may have a curved surface (curved-line shape). By allowing part of the lens end face CS to remain as a flat (linear) contact portion, while using the flat contact portion for contact (positioning), the other part, that is, the curved surface, can be considered to be formed in a shape more fitted to a human face.

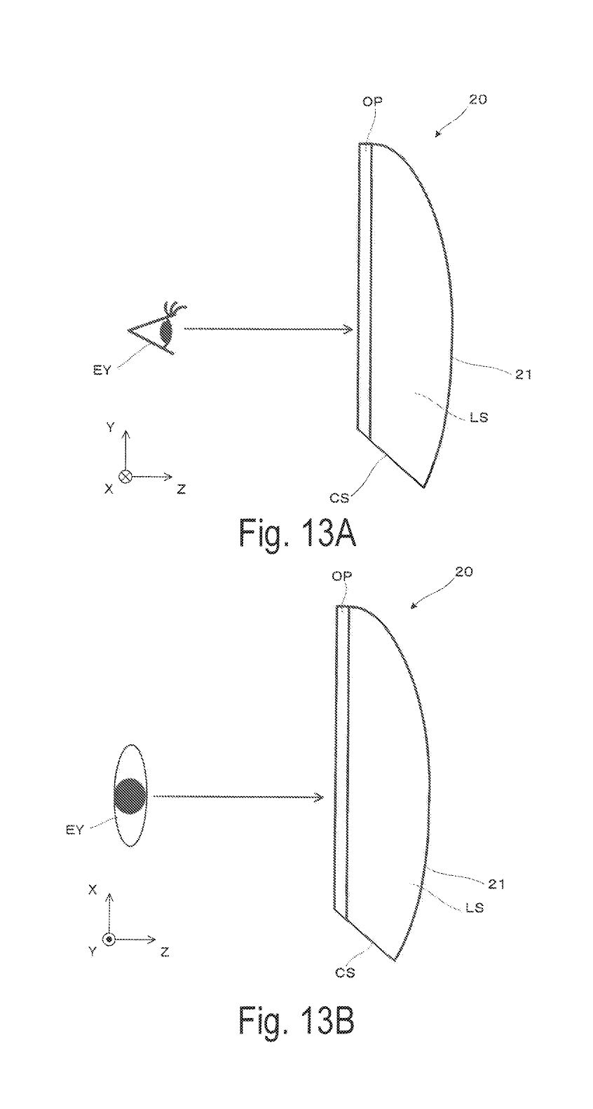

In addition, various aspects can be considered regarding a direction in which the cutting is carried out. For example, as conceptually illustrated in FIGS. 13A and 13B, a lens end face CS may have such a shape that extends in a downward direction (−Y direction) with respect to a +Z direction when viewed from a side, and is slanted to extend in a right-left direction (−X direction in the drawings) with respect to the +Z direction when viewed from above, or may have a taper shape. With this, a shape along a nose shape of the observer can be obtained, for example.

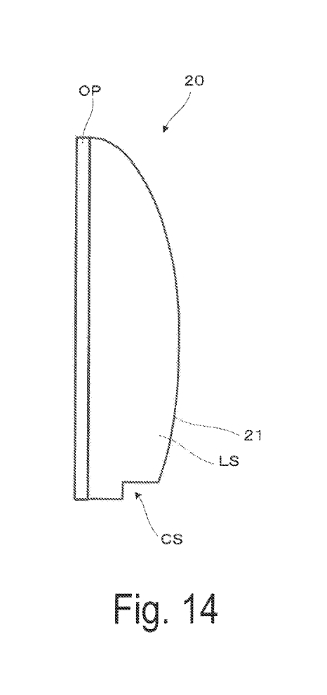

Further, as illustrated in FIG. 14, a portion to be a lens end face CS may be formed in a step-like shape, in other words, formed in a shape including a step. With the above-mentioned shape, the lens end face CS in the step-like shape can be used for positioning.

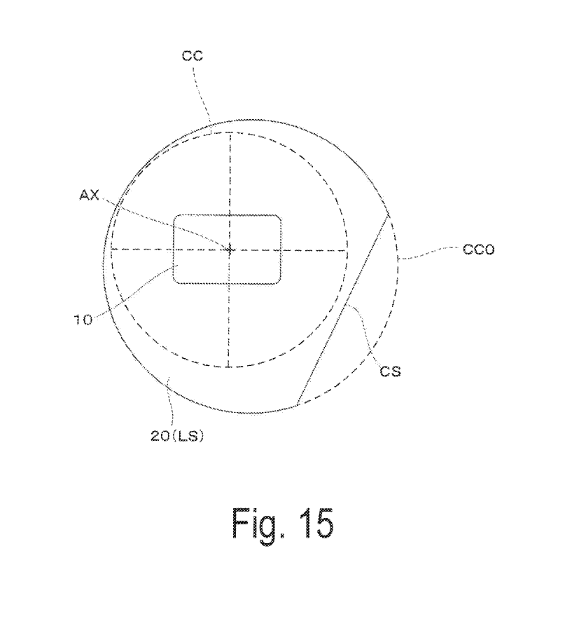

Furthermore, in the above-described examples, a center of a circular member (center of a circle) of the lens before being cut is taken as the optical axis AX, and the center position of the image display unit 10 is also disposed being adjusted to the optical axis AX that is the center of the circular shape before being cut. However, the center position may be set being deviated (shifted) toward a side distanced from the lens end face CS assuming that the original circular shape will be cut and deformed. To be specific, as illustrated in an example of FIG. 15, the position of the optical axis AX may be shifted from the center of a contour CC0 of a shape (circular shape) before being cut as indicated by a broken line. In other words, a contour CC of a circle taking the optical axis AX indicated by a broken line as its center may not form a concentric circle with the contour CC0, and may be shifted toward a side distanced from the lens end face CS. At this time, the center position of the image display unit 10 may also be adjusted to the position-shifted optical axis AX. Alternatively, a similar configuration may be provided by constituting an off-axis optical system, and the like.

As the molding of a member that is to be a lens, the molding of a resin lens by injection molding is cited as an example and described. However, the molding of a lens may be such that the lens is a mold lens of a resin lens produced by another method. In addition, in a case where a glass-made lens is to be produced, molding the lens by glass molding can be considered. That is, in the case where molding is performed by glass molding, molding a desired asymmetric lens by causing the mold shape of the lens to be a non-circular shape in advance, or causing the lens molded in a circular shape to be cut after the molding can be considered.

Further, at the time of building a configuration in which lenses are paired right and left, disposing the lenses based on a reference value (for example, 65 mm) of a distance between light guides, which is a distance between the right and left eyes, can be considered. Furthermore, the cut shape may be set in accordance with the above disposition.

As the image display unit 10 and the like, in addition to HTPS as a transmissive liquid crystal display device, various kinds of configurations other than those described above are available. For example, a configuration using a reflective liquid crystal display device can be employed, or a digital micro-mirror device and the like can be used in place of the image element configured of a liquid crystal display device and the like.

The techniques of the disclosure may be employed in what is called a closed-type (not see-through type) virtual image display device that makes only image light be visually recognized. In addition, the techniques of the disclosure may also be employed in a device enabling an observer to visually recognize or observe an external world image in a see-through manner, may be applied to what is called a video see-through product configured of a display device and an imaging device, and the like.

What is claimed is:

1. A virtual image display device comprising:
an image element configured to display an image; and
an asymmetric lens that is disposed in front of an eye of an observer when the virtual image display device is mounted, the asymmetric lens being configured to cause image light from the image element to be emitted toward an observer side, wherein
in an area within a lens effective diameter range, the asymmetric lens includes a lens end face formed in a region on a nose side of the observer when the virtual image display device is mounted.

2. The virtual image display device according to claim 1, wherein
the lens end face includes a contact portion processed to be flat.

3. The virtual image display device according to claim 1, wherein
the asymmetric lenses are configured to be paired right and left, and the lens end faces are disposed to be symmetrically slanted with respect to a center axis between right and left lenses.

4. The virtual image display device according to claim 1, wherein
the asymmetric lens is a cut lens formed by partially cutting an area within a lens effective diameter range of a circular lens on the nose side of the observer when the virtual image display device is mounted.

5. The virtual image display device according to claim 4, wherein
the asymmetric lens is manufactured by injection molding, and the lens end face is formed by cutting a side of a molded product where residual stress is relatively large.

6. The virtual image display device according to claim 5, wherein
the lens end face is formed by cutting a section including a gate portion at a time of molding.

7. The virtual image display device according to claim 1, wherein
the asymmetric lens includes the lens end faces in a plurality of locations.

8. The virtual image display device according to claim 1, wherein
the asymmetric lens is a resin lens with a property of zero birefringence or low birefringence.

9. The virtual image display device according to claim 1, further comprising:
an attachment section for attaching constituent elements, wherein
the attachment section includes a position determining portion, the position determining portion being configured to make contact with the lens end face and position the lens end face when the asymmetric lens is to be attached.

10. The virtual image display device according to claim 1, wherein
a distance from a position at which the eye of the observer is assumed to be present to a position of the asymmetric lens is within a range from 10 to 30 mm.

11. The virtual image display device according to claim 1, further comprising:
an optical component disposed before the asymmetric lens, wherein
the optical component includes an end face formed in a shape corresponding to the lens end face of the asymmetric lens.

12. The virtual image display device according to claim 11, further comprising:
a display-side lens disposed before the asymmetric lens, the display-side lens being configured to allow image light from the image element to be incident on;
a half mirror disposed before the display-side lens; and
a semi-transmissive polarization plate that is disposed between the asymmetric lens and the display-side lens, the semi-transmissive polarization plate being configured to transmit a component in a polarization transmission axis direction, as the optical components.

13. The virtual image display device according to claim 1, wherein
the image element includes an end face formed in a shape corresponding to the lens end face of the asymmetric lens.
